(19) United States
(12) Patent Application Publication
(10) Pub. No.: US 2020/0189888 A1
(43) Pub. Date: Jun. 18, 2020

(54) TELESCOPING JIB COMPRISING A GUYING SYSTEM FOR A MOBILE CRANE AND GUYING METHOD THEREFOR

(71) Applicant: Terex Global GmbH, Schaffhausen (CH)

(72) Inventor: Laurent Muller, Butten (FR)

(21) Appl. No.: 16/323,712

(22) PCT Filed: Aug. 10, 2017
(86) PCT No.: PCT/EP2017/070348

§ 371 Date: Feb. 6, 2019

(30) Foreign Application Priority Data
Aug. 10, 2016 (DE) 102016114837.7

(51) Int. Cl. B66C 23/70; B66C 23/82

(52) U.S. Cl. CPC B66C 23/702; B66C 23/36; B66C 23/82

(57) ABSTRACT

A telescoping jib of a mobile crane with telescoping sections that telescope inwards and outwards from a jib base casing, and a guying system for the telescoping jib having at least one cable extending between a guying frame and a fixed point by a guying support and is anchored by guying supports, where each guying support comprises a holding mechanism for the cable. A method for guying a telescoping jib of a mobile crane in which at least one cable is anchored between a guying frame on the telescoping jib consisting of a jib base casing and a plurality of telescoping segments and a fixed point on the telescoping jib, and the at least one cable is guided by means of at least one guying support supported on the jib base casing head or a telescoping segment head of the telescoping jib.

### CROSS REFERENCE TO RELATED APPLICATION

The present application claims the priority benefits of International Patent Application No. PCT/EP2017/070348, filed Aug. 10, 2017, and claims benefit of German patent application DE10 2016 114 837.7, filed Aug. 10, 2016.

### BACKGROUND OF THE INVENTION

The invention relates to a telescoping jib of a mobile crane with a plurality of telescoping sections which can telescope inwards and outwards from a jib basic box and with a guying system for guying the telescoping jib, which guying system comprises at least one cable which extends between at least one tensioning frame and at least one fixed point by means of at least one guying support, and the guying support comprises a holding mechanism for the cable.

Furthermore, the invention relates to a method for guying a telescoping jib of a mobile crane, in which at least one cable is guyed between a tensioning frame on the telescoping jib, consisting of a jib basic box and a plurality of telescoping sections, and a fixed point on the telescoping jib, and the at least one cable is guided by means of at least one guying support supported on the jib basic box head or a telescoping section head of the telescoping jib.

A telescoping crane jib is known from the German laid-open document DE 10 2015 009 156 A1. The crane jib consists of a base section and one or more telescoping sections. In order to increase the load-bearing capacity of the crane jib a guying arrangement is provided consisting of a single pair of guying supports and traction means. The pair of guying supports is disposed in a v shape on a head end of a first telescoping section and extends perpendicularly to the crane jib. The traction means are on the one hand fastened at a foot end of the base section to cable winches and on the other hand to a head end of a second telescoping section. The two traction means also extend along the crane jib and are each guided via one of the two guying supports in the region of their free ends. For this purpose deflecting rollers are disposed on each of the guying supports and the respective cable is looped around them at least once. Each deflecting roller can be fixed via a holding function. The traction means are wound or unwound by the cable winches as the crane jib is being retracted and extended and are then tensioned after extension has taken place. After tensioning, the deflection rollers are also fixed. The tensioning of the traction means causes the crane jib to be relieved of loading and sagging of the crane jib is reduced or avoided.

The German patent document DE 34 47 095 C2 discloses a further telescoping jib on a superstructure of a crane. The telescoping jib is guyed by an arrangement of tensioning cables and deflecting rollers. The tensioning cables are respectively fastened to each head end of the respective telescoping sections and come together at a tensioning cylinder attached to the superstructure.

A mobile crane with a telescoping crane jib with three telescoping partial jibs is known from the European patent document EP 2 504 267 B1. The partial jibs extend in parallel and spaced apart from each other. The spacing is achieved via triangular connection plates, the partial jibs respectively extending in the corners thereof. The connection plates are each disposed in the region of head ends of the partial jibs and at a foot end of the base partial jib.

The U.S. Pat. No. 4,982,853 A discloses a mobile crane with a telescoping jib basic box and a plurality of telescoping sections which support a guying system. The guying system consists of three cables and has two guying supports attached to the end of the telescoping section heads so that the telescoping jib is guyed. One of the cables runs over deflecting rollers through one of the guying supports and is fastened to the head of the telescoping section. A holding mechanism for one of the cables is not shown.

German laid-open document DE 103 15 989 A1 likewise describes a mobile crane with a telescoping jib consisting of a plurality of telescoping sections. In order to guy or pre-tension the telescoping jib a tensioning cable is guided from a cable winch via a roller on a first guying support and through a second guying support, deflected at a roller at the tip of the mast into the telescoping jib and secured at a fastening point. The first guying support is fastened to an inner end of the jib basic box and comprises no through-hole for the cable but rather a roller disposed above. Moreover, not every telescoping section has a guying support and holding mechanisms for the cable are not provided.

A telescoping jib with a telescoping jib basic box and a plurality of telescoping sections is known from the Chinese utility model CN 202 558 505 U. A first guying system consisting of a centrally attached main guying support and two laterally attached guying supports is fastened to the telescoping jib basic box. A second guying system is located on one of the telescoping sections and likewise consists of three guying supports, one disposed centrally and two laterally. Cables extend through the guying supports and are fastened to the head of the mast. The first guying system is neither attached to the head of the jib basic box nor is a guying support or holding mechanisms for the cables located on each telescoping section.

The German utility model DE 202 19 126 U1 discloses a telescoping jib of a crane with a telescoping jib basic box and a plurality of telescoping sections. A guying arrangement is provided with two guying cables in order to guy the telescoping jib, said cables being guided over deflecting rollers disposed on guying brackets. However, a guying support is not provided on each telescoping section and in particular on the head of the jib basic box. Moreover, no holding mechanisms for the guying cables are disclosed.

### SUMMARY OF THE INVENTION

The object of the invention is to create a telescoping jib for a mobile crane with a guying system and a guying method therefor having a constructionally simplified and lighter construction and an increase in the bearing load while the telescoping jib dimensions remain unchanged.

In accordance with an embodiment of the invention, in a telescoping jib of a mobile crane with a plurality of telescoping sections which can telescope inwards and outwards from a jib basic box and with a guying system for guying the telescoping jib, which guying system comprises at least one cable which extends between at least one tensioning frame and at least one fixed point by means of at least one guying support, and the guying support has a holding mechanism for the cable an increase in the bearing load and a constructionally simplified and lighter construction is achieved in that in each case at least one guying support is disposed at the outer end of a jib basic box head and in each case at least one guying support is disposed at the outer end of a telescoping section head and the guying support on the telescoping section head of the innermost telescoping section supports the fixed point and the guying supports on the remaining telescoping sections and on the jib basic box support a holding mechanism for the cable. The guying supports are fixedly disposed on the jib basic box and on at least one of the telescoping sections. This renders bracing of the guying system unnecessary. The higher number of guying supports means that as a whole a lighter and more compact construction, in particular construction height, can be achieved during transportation.

The holding mechanism holds the cable by means of a frictional and/or interlocking connection.

A space-saving implementation of the guying system is achieved in that in accordance with the invention each guying support is disposed in each case at the outer end of a jib basic box head or of a telescoping section head. In this way the telescoping jib is not prevented from telescoping inwards completely. This therefore allows a reduction in the telescoping jib to a compact size in the transportation condition.

In a further embodiment of the invention, provision is made that a guying support is disposed in each case on the jib basic box and on each telescoping section. The telescoping jib can thus be guyed at a plurality of points, which in turn increases the stability of the guying arrangement and improves the bearing load of the telescoping jib. A lighter and smaller construction can thus also be implemented for the same bearing load.

The guying system is constructionally simplified in that each guying support comprises a through-hole for the cable which is to be passed through.

For a particularly simple implementation of the guying system, provision is made that the holding mechanism comprises a movable holding element with which the cable can be secured in an operating condition in the through-hole against a counter holding element.

In a further embodiment of the invention, provision is made that the at least one tensioning frame of the guying system is disposed on the jib basic box.

A constructional simplification is achieved in that the cable is secured to the tensioning frame and to the last telescoping section head of the last telescoping jib.

This results in a fixedly installed, space-saving guying system which requires no further bracing.

A further improvement in the stability and bearing load of the telescoping jib is achieved in that a first tensioning frame and a second tensioning frame are disposed on the jib basic box and cooperate with a first cable and a second cable which extend in parallel with each other and in the longitudinal direction of the telescoping jib.

A particularly secure and stable guying arrangement is achieved in that each guying support comprises two limbs which, as seen in the longitudinal direction of the telescoping jib, from the middle of the telescoping jib, are disposed on the right and left on the telescoping jib and form an angle of 45° to 135°, preferably 90°.

In order to design the telescoping jib in a space-saving but stable manner provision is made that successive telescoping sections and the jib basic box can be secured to one another.

A simplified and space-saving method for guying a telescoping jib, in which at least one cable is guyed between a tensioning frame on the telescoping jib, consisting of a jib basic box and a plurality of telescoping sections, and a fixed point on the telescoping jib, and the at least one cable is guided by means of at least one guying support supported on the jib basic box head or a telescoping section head of the telescoping jib is achieved in that the telescoping sections are extended out of the jib basic box, the at least one cable is tensioned between the tensioning frame and the fixed point and the at least one cable is secured on the guying support via a holding mechanism.

An improvement in the bearing load is achieved by a method in that, starting from a transportation condition of a retracted telescoping jib, beginning with the last telescoping section in the longitudinal direction of the telescoping jib and continuing with the adjoining telescoping section in each case, after each extension of a telescoping section the at least one cable of the guying system is tensioned by the at least one tensioning frame and secured by the holding mechanism.

An exemplified embodiment of the invention is explained in greater detail hereinafter.

### BRIEF DESCRIPTION OF THE DRAWINGS

FIG. 1 shows a perspective view of a mobile crane with a telescoping jib;

FIG. 2 shows a perspective partial view of a mobile crane according to FIG. 1 with a partially extended telescoping jib;

FIG. 3 shows a perspective plan view of a completely extended telescoping jib;

FIG. 4 shows a view of a detail of a guying support on the telescoping jib;

FIG. 5 shows a schematic illustration of a holding mechanism using a frictional connection;

FIG. 6 shows a schematic illustration of a further holding mechanism using a frictional connection;

FIG. 7 shows a schematic illustration of a holding mechanism using a frictional and interlocking connection;

FIG. 8 shows a schematic illustration of a holding mechanism using an interlocking connection; and

FIG. 9 shows a schematic illustration of a further holding mechanism using an interlocking connection.

### DESCRIPTION OF THE PREFERRED EMBODIMENTS

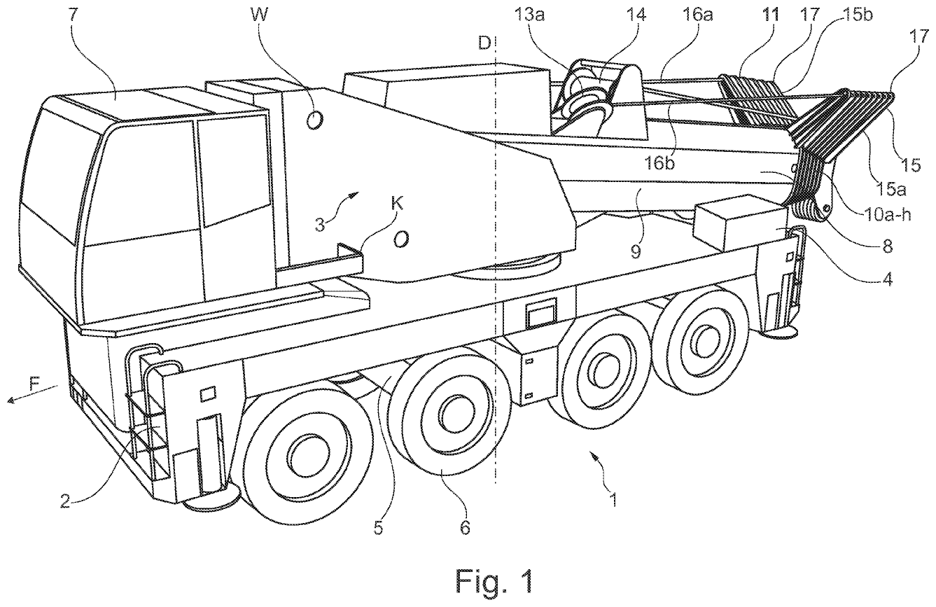

FIG. 1 shows a perspective view of a mobile crane designated by 1. The mobile crane 1 comprises essentially a lower carriage 2 and a superstructure 3. The lower carriage 2 supports counterweights 4 and comprises four vehicle axles 5 each with two wheels 6 suitable for road travel. Furthermore, the lower carriage 2 supports the superstructure 3, which can pivot with respect to the lower carriage 2 about a substantially vertically orientated axis of rotation D. The superstructure 3 and lower carriage 2 can naturally also be rigidly mounted one on another. A combined driver's and crane operator's cabin 7 which can pivot about a vertical axis K from front to back and vice versa and a telescoping jib 8 are attached to the superstructure 3, which telescoping jib is fully retracted and laid down on the lower carriage 2 opposite to a forwards travel direction F of the mobile crane 1 for road travel. It is naturally also possible to form the driver's and crane operator's cabin 7 separately from each other.

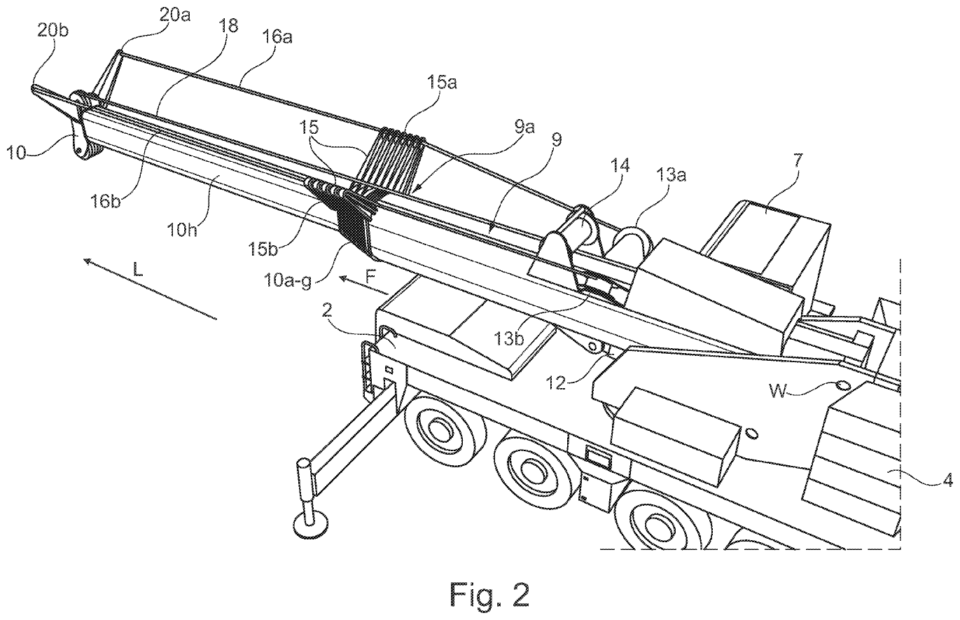

The telescoping jib 8 has a guying system 11 in order to achieve an increase in the bearing load while keeping the dimensions of the telescoping jib 8 unchanged, and consists of a jib basic box 9 and a plurality of telescoping sections 10a-h. The jib basic box 9 is connected at its foot to the superstructure 3 via a horizontal luffing axis W and can be erected via a luffing cylinder 12 (see FIG. 2 in relation thereto). Tensioning frames 13a, 13b of the guying system 11 and a lifting mechanism 14 are also located on the jib basic box 9 and therefore not on the superstructure 3. The tensioning frames 13a, 13b are designed as driven, breakable and fixable winches with an electrical or hydraulic drive and a drum for a cable 16a, 16b which can be wound and unwound. However, attachment of the tensioning frames 13a, 13b at that location and not on the jib basic box 9 is also possible. The jib basic box 9 receives the telescoping sections 10a-h within it in a conventional manner, these each being disposed one inside another and being extendible and retractable. In the extended condition, the telescoping sections 10a-h are connected to one another via bolts. The foot of the inner, and therefore smaller, telescoping section 10a-h in each case is bolted, by means of a fitting bolting position hole, to the next outer and larger telescoping section 10a-h in each case or to the jib basic box 9. In FIG. 2, the foot of the telescoping section 10h is therefore connected to the bolting position hole of the telescoping section 10g located on the head 10. The guying system 11 comprises v-shaped guying supports 15 disposed on the outer end—as seen in the longitudinal direction L of the telescoping jib 8—of a head 9a of the jib basic box 9 and of a head 10 of each telescoping section 10a-h. Each v-shaped guying support 15 comprises a first limb 15a and a second limb 15b. The first limbs 15a and second limbs 15b of the guying supports 15 are each disposed—as seen with the telescoping jib 8 orientated horizontally—on the outside and at the top in the region of corners of the telescoping sections 10a-h, which have a substantially four-sided cross-section, or of the jib basic box 9, which has a substantially four-sided cross-section, and extend upwards and outwards in an inclined manner. An opening angle a of the two limbs 15a and 15b is about 45-135°, preferably 90°. In this case, both limbs 15a and 15b lie in a common notional plane which is orientated at a right angle to a longitudinal direction L of the telescoping jib 8. The limbs 15a and 15b themselves have a stretched triangle-like shape, wherein a base side of the triangle lies on the telescoping section 10a-h or on the jib basic box 9 and a point of the triangle is provided with a respective through-hole 22a and 22b for the first cable 16a or the second cable 16b. The cables 16a and 16b are fastened respectively to the left or right limb 15a and 15b of the last telescoping section 10h—i.e. the one furthest from the jib basic box 9—at a fixed point 20a and 20b on the respective guying support 15. One of the two cables 16a and 16b is guided respectively over all the right and all the left limbs 15a and 15b of the guying supports 15 and fastened and tensioned at the foot of the jib basic box 9 at one of the right and left tensioning frames 13a and 13b located at the opposing end (see FIG. 2 in relation thereto). A respective holding mechanism 17, which secures the cables 16a and 16b after tensioning, is located at the end of the limbs 15a and 15b of the jib basic box 9 and of the telescoping sections 10a-g except on the last telescoping section 10h. The tensioning of the cables 16a and 16b is preferably effected by a combination of tensioning via the tensioning frames 13a and 13b, firm holding in the holding mechanisms 17 and further tensioning by outwards telescoping of the respective telescoping section 10a-h. It is fundamentally also feasible to tension either only by means of the tensioning frames 13a and 13b or by the outwards telescoping movement. Finally, the cables 16a and 16b are therefore secured and tensioned at a plurality of points between the fixed points 20a and 20b on the last telescoping section 10h and the tensioning frames 13a and 13b in the region of the guying supports 15. The guying system 11 is therefore fixedly installed on the mobile crane 1 and requires no subsequent bracing.

FIG. 2 shows a perspective partial view of a mobile crane 1 according to FIG. 1 with a partially extended telescoping jib 8. The last telescoping section 10h is extended; the remaining telescoping sections 10a-g are still retracted. For crane operation, the superstructure 3 is rotated by 180° from the position for road travel (see FIG. 1 in relation thereto) so that the telescoping jib 8 points in the forwards travel direction F. The driver's and crane operator's cabin 7 has now been displaced into a position suitable for crane operation, laterally of the superstructure 3. On the upper side and in the foot region of the jib basic box 9, the two tensioning frames 13a and 13b are disposed in the region of the corners of the telescoping jib 8 in such a way that the drums thereof point upwards and outwards and a rolling axis of the tensioning frames 13a and 13b is at a right angle to the longitudinal direction L of the telescoping jib 8. The lifting mechanism 14 is disposed thereafter as seen in the direction of the head 9a of the jib basic box 9. The drum of the lifting mechanism 14 points upwards and a rolling axis of the lifting mechanism 14 is likewise disposed at a right angle to the longitudinal direction L of the telescoping jib 8. A lifting cable 18 is wound and unwound by the lifting mechanism 14 and extends from the lifting mechanism 14 along and above the telescoping jib 8 to the end of the last telescoping section 10h. At the end of the last telescoping section 10h is a deflecting roller 19, over which the lifting cable 18 is guided.

The operation of the guying system 11 will be explained hereinunder with the aid of FIG. 2. In a first step, the innermost telescoping section 10h of the telescoping jib 8 is extended and at the same time the cables 16a, 16b secured in the fixed points 20a, 20b of the limbs 15a and 15b of the guying support 15 of the innermost telescoping section 10h are carried along in the longitudinal direction L of the telescoping jib 8 and therefore unwound from the tensioning frames 13a, 13b. In this case, the cables 16a, 16b are guided through the through-holes 22a, 22b of the guying supports 15 of the other telescoping sections 10a-g which have not yet been extended. In the retracted condition of the telescoping sections 10a-h, the guying supports 15 lie closely against one another with little spacing. Shortly before reaching a desired bolting position of the innermost telescoping section 10h, the cables 16a and 16b, which are already subject to basic tensioning via the tensioning frames 13a, 13b, are secured on the limbs 15a and 15b by the two holding mechanisms 17 of the adjacent telescoping section 10g. Owing to further extension of the telescoping section 10h into its bolting position for the full extension path, the upper part of the cables 16a, 16b is then further tensioned between the fixed points 20a, 20b of the limbs 15a and 15b of the guying support 15 of the innermost telescoping section 10 and the two holding mechanisms 17 of the adjacent telescoping section 10g. It is fundamentally possible to provide different bolting positions for each telescoping section 10a-h, these bolting positions then fixing a telescoping section 10a-h in a full or half or otherwise preselected extension path of the telescoping section 10a-h. In a similar manner, the cables 16a, 16b are then successively tensioned in portions between the respective guying supports 15 of the telescoping sections 10a-g and of the jib basic box 9 in parallel with the extension and bolting of the further telescoping sections 10a-g. It is important in this that the guying of the cables 16a, 16b takes place not only between the fastening points 20a and 20b and the tensioning frames 13a and 13b, but also between the guying supports 15 adjacent thereto and in each case between the adjacent guying supports 15.

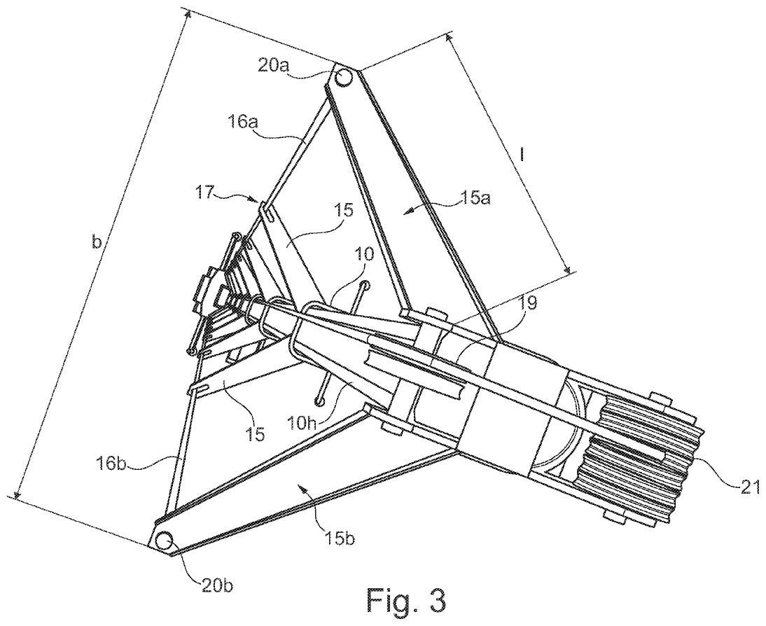

FIG. 3 shows a perspective plan view of a completely extended telescoping jib 8. The guying supports 15 are disposed on each telescoping section head 10 and on the jib basic box head 9a and therefore spaced apart from one another. The limbs 15a and 15b of the guying support 15 are disposed laterally on the right and left on the telescoping jib 8. The cables 16a and 16b are fastened to the limbs 15a and 15b of the guying support 15 of the last telescoping section 10h at a first and second fixed point 20a and 20b. The lifting cable 18 extending between the limbs 15a and 15b of the last telescoping section 10h extends below the limbs 15a and 15b over a deflecting roller 19 and then over a guide roller 21.

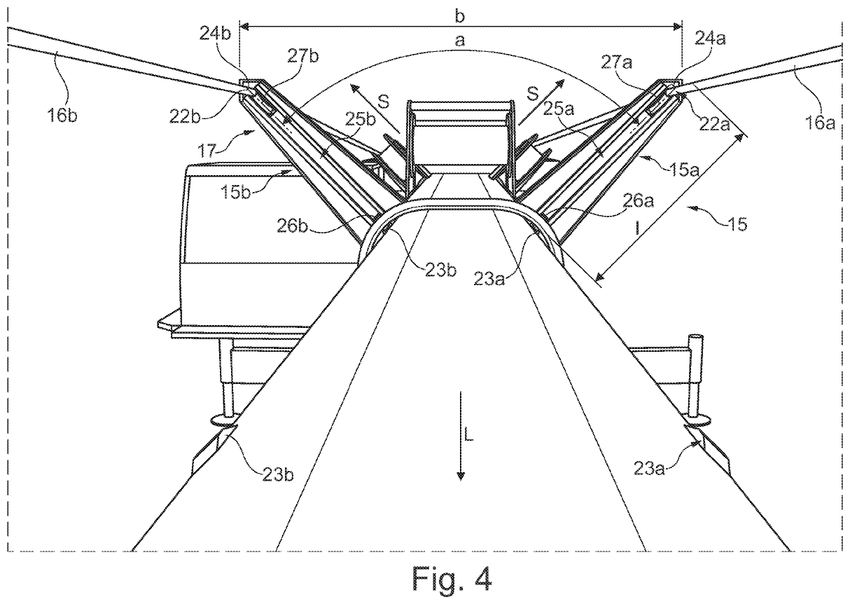

FIG. 4 shows a view of a detail of the limbs 15a and 15b of a guying support 15 of the telescoping jib 8. The holding mechanism 17 consists in each case substantially of a first counter holding element 24a or second counter holding element 24b, which each cooperate with a first holding element 27a, in particular in the form of a cable roller, or with a second holding element 27b, in particular in the form of a cable roller, in order to secure or clamp-in the respective cable 16a, 16b therebetween. The counter holding element 24a, 24b is in each case formed as a stationary contact surface of the respective limb 15a and 15b and is located in each case at an end of the limbs 15a and 15b remote from the telescoping jib 8 and adjoining the through-holes 22a and 22b. The contact surface is adapted to the contour of the cable 16a, 16b and can have increased frictional resistance. In order to be able to move the holding elements 27a, 27b in a pushing direction S, which is parallel to the longitudinal extension of the limbs 15a and 15b, in the direction of the counter holding elements 24a, 24b, each of the limbs 15a and 15b receives a rod-like pushing element 25a, 25b. The pushing element 25a, 25b is therefore integrated into the respective limb 15a and 15b and, at its end remote from the telescoping jib 8, receives a respective one of the holding elements 27a, 27b. In order to be able to press the cable 16a, 16b onto the counter holding elements 24a, 24b by means of the holding elements 27a, 27b, the pushing element 25a, 25b can be displaced along the limb 15a and 15b of the guying support 15. A sliding movement is achieved by a running roller 26a, 26b disposed on the end of the pushing element 25a, 25b facing the telescoping jib 8, which running roller rolls in the longitudinal direction L along the outer surface of the telescoping jib 8 and, in the region of the preselected bolting position, on wedge-shaped guide elements 23a, 23b in the form of raised areas on the outer surface of the telescoping jib 8 and therefore brings about a movement of the pushing element 25a, 25b in the pushing direction S so that the cable 16a, 16b is secured or clamped in the region of the bolting position. In order to be able to travel over bolting positions without causing tensioning of the cable 16a, 16b, only a basic tensioning is provided on the cable 16a, 16b by means of the tensioning frames 13a, 13b when further tensioning is then also to be effected via the holding mechanism 17. Without the basic tensioning, the cable 16a, 16b, when travelling over a non-selected bolting position, is clamped briefly in the non-tensioned condition only by the guide element 23a, 23b and immediately released.

In the exemplified embodiment, the width b is about 200 cm and the length I of the limbs 15a, 15b about 95 cm. These dimensions can naturally be different. When establishing the dimensions of the guying supports 15, the correct compromise must be found according to the size of the telescoping jib 8 and of the mobile crane 1 (crane length, crane width, possible jib angle deviation) in order to achieve an increase in bearing load without exceeding the legal vehicle width and height for road operation.

A mechanical embodiment of the holding mechanism 17 is described above. It is fundamentally also possible to envisage driving the holding mechanisms 17 electrically, hydraulically or pneumatically. Instead of the holding elements 27a, 27b and running rollers 26a, 26b, sliding elements can also be provided. The guide elements 23a, 23b, which are preferably designed as wedges, and the pushing elements 25a, 25b can be replaced by other elements which fix the relative movement of the telescoping sections 10a-h with respect to each other during retraction and extension into a fixture of the cable 16a, 16b, preferably by clamping.

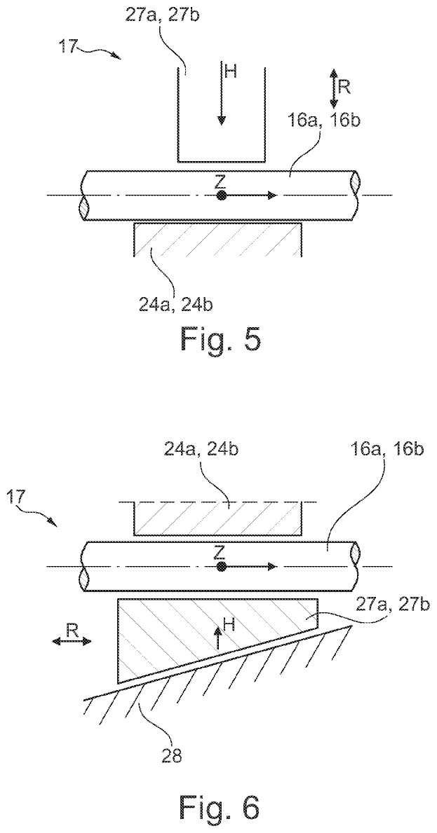

FIGS. 5 to 9 illustrate, in addition to the embodiment depicted in FIG. 4, five further embodiments of a holding mechanism 17. However, the invention is not to be limited to these five exemplified embodiments.

By means of the holding force H applied by the holding mechanism 17, it is fundamentally possible to hold the cable 16a, 16b on the guying support 15 by a frictional connection and/or by an interlocking connection by means of the holding mechanism 17.

FIGS. 5 and 6 show exemplified embodiments of a holding mechanism 17 which holds the cable 16a, 16b by means of a frictional connection. For this purpose, a first holding element 27a or a second holding element 27b is moved in a linear actuation direction R from an open position into a holding position. In the holding position, the holding element 27a, 27b acts with a holding force H on the cable 16a, 16b and presses it against the first counter holding element 24a and the second counter holding element 24b respectively. In a corresponding manner, the holding force H therefore acts at a right angle with respect to the longitudinal direction of the cable 16a, 16b and in the direction of the opposing counter holding element 24a, 24b.

In FIG. 5, the cable 16a, 16b is clamped-in in a frictionally connected manner between the holding element 27a, 27b, pushed in the actuation direction R, and the counter holding element 24a, 24b.

In FIG. 6, the holding element 27a, 27b is designed as a clamping wedge which can be displaced along a ramp 28 in the actuation direction R. The ramp 28 extends in parallel with the longitudinal direction of the cable 16a, 16b and rises as seen in the longitudinal direction of the cable 16a, 16b. By means of a movement of the holding element 27a, 27b into the holding position, the holding element 27a, 27b is moved via the ramp 28 towards the cable 16a, 16b in the direction of the holding force H and therefore presses the cable 16a, 16b against the counter holding element 24a, 24b, which is therefore clamped in a frictionally connected manner. In addition, the wedge-shaped holding element 27a, 27b has an effect which increases the clamping force. If the cable 16a, 16b is pulled further in the tensioning direction Z, this entrains the wedge-shaped holding element 27a, 27b by a frictional connection. This thereby moves further up the ramp 28 and increases the holding force H in the direction of the cable 16a, 16b.

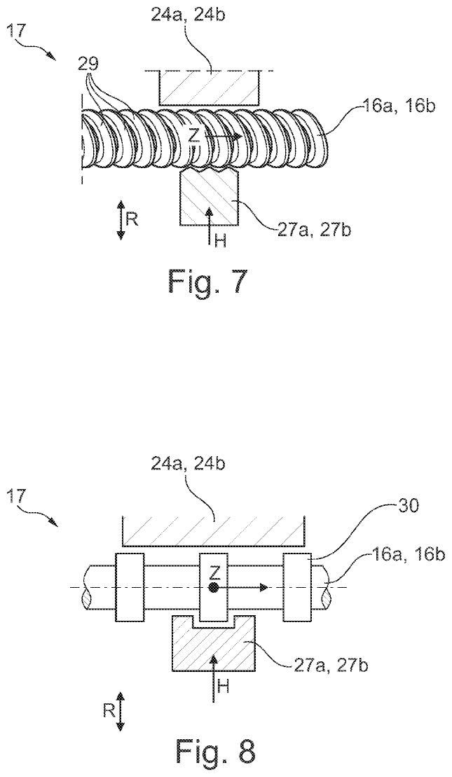

The exemplified embodiment illustrated in FIG. 7 presents a combined holding mechanism 17 operating with frictional and interlocking connection. This is fundamentally comparable with the embodiment illustrated in FIG. 5. However, in addition, the holding element 27a, 27b is provided with profiling on its surface facing the cable 16a, 16b, which profiling is formed to be substantially complementary to the outer surface of the cable 16a, 16b and therefore engages in an interlocking manner into the surface of the cable 16a, 16b. In this case, the turns 29 of the cable 16a, 16b form a surface of the cable 16a, 16b with a coil-like and thread-like structure.

The holding mechanism 17 according to the exemplified embodiment in FIG. 8 also uses an interlocking connection. The holding element 27a, 27b is displaced in the actuating direction R as shown in FIGS. 5 and 7. The cable 16a, 16b is provided, at least in the region of the holding mechanism 17, with formed parts 30 pressed one behind another and spaced apart from each other in the longitudinal direction. In order to be able to produce an interlocking connection instead of a frictional connection between the holding elements 27a, 27b, the holding element 27a, 27b is provided, on its surface facing the cable 16a, 16b, with profiling which is formed in a complementary manner to the outer surface of the cable 16a, 16b with its formed parts 30. At least one formed part 30 is received in the holding position by the holding element 27a, 27b. There may also be several if required. In addition to the holding element 27a, 27b the counter holding element 24a, 24b can also preferably be provided with profiling (not illustrated) which is suitable for receiving the formed parts 30 and therefore additionally prevents the cable 16a, 16b from being pulled in the tensioning direction Z.

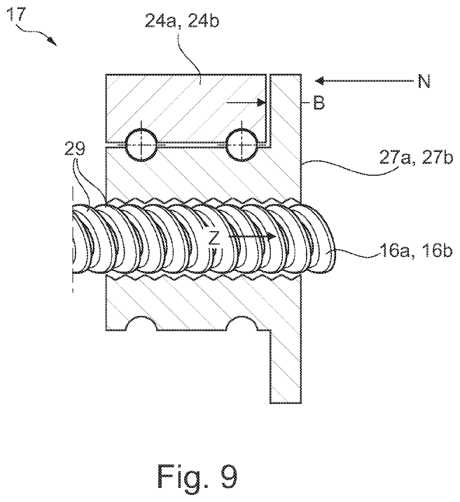

The holding mechanism 17 illustrated in FIG. 9 is likewise essentially an interlocking connection which is used to secure the cable 16a, 16b. FIG. 9 illustrates a holding element 27a, 27b which is attached, in the manner of a nut, to the cable 16a, 16b with its profiled, thread-like outer surface. These holding elements 27a, 27b can correspondingly rotate about the thread produced by the cable turns 30 when the cable 16a, 16b is moved in or opposite to the tensioning direction Z, e.g. during extension and retraction of the telescoping jib 8. In order to move the holding mechanism 17 from its open position into its holding position, in this embodiment, the rotational movement of the holding element 27a, 27b is to be blocked. For this purpose, a blocking device, e.g. a brake, is to be provided between the counter holding element 24a, 24b, in which the holding element 27a, 27b is rotationally mounted, and the holding element 27a, 27b. In FIG. 9, this is indicated by the arrow B. When the holding element 27a, 27b is prevented from rotating, the holding element 27a, 27b holds the cable 16a, 16b opposite to the tensioning direction Z in a manner comparable to the embodiment according to FIG. 7.

Furthermore, it is self-evident that the guying system 11 also functions with chains instead of with cables 16a, 16b so that, in terms of the invention, the cables 16a, 16b are to be understood as flexible tensioning means.

1. A telescoping jib of a mobile crane comprising a plurality of telescoping sections that telescope inwards and outwards from a jib basic box and a guying system for the telescoping jib, wherein the guying system comprises at least one cable that extends between at least one tensioning frame and at least one fixed point via at least two guying supports, wherein each guying support is disposed in each case at the outer end of a jib basic box head or of a telescoping section head and comprises a holding mechanism for the cable, and wherein the holding mechanism holds the cable by a frictional and/or interlocking connection.

2. The telescoping jib as claimed in claim 1, wherein a further guying support supports the fixed point on the telescoping section head of an innermost telescoping section.

3. The telescoping jib as claimed in claim 2, wherein a guying support is disposed on the jib basic box and each telescoping section respectively.

4. The telescoping jib as claimed in claim 3, wherein each guying support comprises a through-hole for the cable which is to be passed through.

5. The telescoping jib as claimed in claim 4, wherein the holding mechanism comprises a movable holding element with which the cable can be secured in an operating condition in the through-hole against a counter holding element.

6. The telescoping jib as claimed in claim 5, wherein the at least one tensioning frame of the guying system is disposed on the jib basic box.

7. The telescoping jib as claimed in claim 6, wherein the cable is secured on the tensioning frame and on a last telescoping section head of a last telescoping jib.

8. The telescoping jib as claimed in claim 7, wherein a first tensioning frame and a second tensioning frame are disposed on the jib basic box and cooperate with a first cable and a second cable which extend in parallel with each other and in the longitudinal direction of the telescoping jib.

9. The telescoping jib as claimed in claim 8, wherein each guying support comprises two limbs which, as seen in the longitudinal direction of the telescoping jib, from a middle of the telescoping jib, are disposed on the right and left on the telescoping jib and form an angle of 45 degrees ° to 135 degrees.

10. The telescoping jib as claimed in claim 9, wherein the successive telescoping sections and the jib basic box can be secured to one another.

11. (canceled)

12. (canceled)

13. The telescoping jib as claimed in claim 1, wherein a guying support is disposed on the jib basic box and each telescoping section respectively.

14. The telescoping jib as claimed in claim 1, wherein each guying support comprises a through-hole for the cable which is to be passed through.

15. The telescoping jib as claimed in claim 14, wherein the holding mechanism comprises a movable holding element with which the cable can be secured in an operating condition in the through-hole against a counter holding element.

16. The telescoping jib as claimed in claim 1, wherein the at least one tensioning frame of the guying system is disposed on the jib basic box.

17. The telescoping jib as claimed in claim 1, wherein the cable is secured on the tensioning frame and on a last telescoping section head of a last telescoping jib.

18. The telescoping jib as claimed in claim 1, wherein a first tensioning frame and a second tensioning frame are disposed on the jib basic box and cooperate with a first cable and a second cable which extend in parallel with each other and in the longitudinal direction of the telescoping jib.

19. The telescoping jib as claimed in claim 18, wherein each guying support comprises two limbs which, as seen in the longitudinal direction of the telescoping jib, from a middle of the telescoping jib, are disposed on the right and left on the telescoping jib and form an angle of 45 degrees to 135 degrees.

20. A method for guying a telescoping jib of a mobile crane, wherein the telescoping jib comprises a jib basic box and a plurality of telescoping sections, and wherein at least one cable is guyed between a tensioning frame on the telescoping jib and a fixed point on the telescoping jib, and wherein the at least one cable is guided by at least two guying supports supported on the jib basic box head or a telescoping section head of the telescoping jib, wherein the method comprises extending the telescoping sections out of the jib basic box, tensioning the at least one cable between the tensioning frame and the fixed point, and securing the at least one cable on each guying support via a holding mechanism.

21. The method as claimed in claim 20, wherein tensioning the at least one cable between the tensioning frame and the fixed point comprises starting from a transportation condition of a retracted telescoping jib, beginning with the last telescoping section in the longitudinal direction of the telescoping jib and continuing with the adjoining telescoping section in each case, after each extension of a telescoping section the at least one cable of the guying system is tensioned by the at least one tensioning frame and secured by the holding mechanism.
